(19) United States
(12) Patent Application Publication
(10) Pub. No.: US 2011/0302002 A1
(43) Pub. Date: Dec. 8, 2011

(54) LEARNING OPTIMAL PRICES

(75) Inventors: Christopher R. Dance, Grenoble (FR); Onno Zoeter, Grenoble (FR)

(73) Assignee: XEROX CORPORATION, Norwalk, CT (US)

(21) Appl. No.: 12/792,028

(22) Filed: Jun. 2, 2010

(51) Int. Cl. G06Q 10/00; G06N 5/02; G06Q 30/00

(52) U.S. Cl. 705/7.35; 705/14.13; 706/52; 705/7.29

(57) ABSTRACT

A method comprises: presenting a plurality of offers to one or more offerees, the offers including at least one non-deterministic offer having non-deterministic consideration for the offeree; conducting business activity including the presenting and further including at least one actual business transaction executed in response to an acceptance by an offeree of one of the plurality of offers; receiving offeree decision data during the conducting of business activity; and generating valuation information based on the offeree decision data. Optionally the method further includes generating a new offer based on the generated valuation information and conducting additional business activity including presenting the new offer. Optionally the method is performed using n offeree folds wherein the generating of a new offer for an i^{th} offeree fold is based on the generated valuation information for offeree folds other than the i^{th} offeree fold.

### BACKGROUND

Marketing of products entails balancing the valuations placed on items by a buyer against the prices (or, more generally, contracts) set by the seller. In general, if the buyer's valuation of an item is greater than the price of the item, then the sale is likely to occur; conversely, if the buyer's valuation is less than the price of the item then no sale is likely.

More quantitatively, a “buyer's surplus” from a purchase can be identified as the difference between the buyer's valuation of the item and the sale price. A “seller's profit” is determined by the sale price minus the cost to the seller in obtaining and marketing the item. The seller would like to sell the item at the highest price possible, since this maximizes the seller's revenue; however, if the price is set too high, and more particularly above the buyer's valuation, then no sale will occur and no revenue is obtained. Further complicating the situation is that in the case of multiple buyers, different buyers may place different values on the item, or an individual buyer may have different valuations at different times.

In existing approaches, the seller sets the price for an item based on the seller's past experience or other available information, and then adjusts the price upward or downward over time based on sales. For example, if an unexpectedly low number of sales is achieved at the initial price, the seller may lower the price in order to encourage additional sales. Conversely, if sales are brisk at the initial price then the seller may try increasing the price. If sales volume is maintained (or decreases only slightly) at the higher price, then the seller's revenue is increased. These approaches are sometimes referred to as censored price experiment (CPE) approaches. The seller estimates the distribution of buyers' valuations from censored observations (that is, observations that the valuation is greater than the price or that the valuation is less than the price; more generally a censored observation is one that is only known to come from some set).

Such approaches have numerous disadvantages, such as being relatively slow and imprecise. For example, if the price is increased by 20% and sales remain brisk, the seller does not know whether or not a further 10% price increase would also be acceptable to buyers, and can only determine this information by further price experimentation, which takes more time. Lost seller's revenue during the slow price optimization can be substantial. Frequent manipulation of pricing can also be problematic, since it can annoy buyers. If the price is set too high then buyers may go elsewhere, and may not return to the seller even if the seller later lowers the price. It is also possible for past price adjustments to affect the current price “experiment”. For example, if the seller frequently changes the price, then a buyer may learn to wait for a low price point in the buyer-perceived pricing “cycle” before making a purchase. Slow adjustment of price over time can also fail to identify more rapid market changes that may modify the optimal price. For example, seasonal variations in demand may not be detected, and as a result the price may be set too high (or too low) at certain times of the year.

Other approaches have been attempted for price optimization. These approaches typically are variants of the price adjustment scheme, sometimes under different nomenclature. For example, in the automotive industry it is known to offer price rebates to encourage purchases. Such rebates are simply short-term price adjustments. The same problems arise. For example, at certain times American car buyers have come to expect certain automobile manufacturers to offer frequent rebates, and delay purchase until the next rebate offer.

Other approaches attempt to rely upon self-reporting by buyers. An extreme example of this is the “pay what you like” restaurant model. In this model, the buyer actually sets the price by being allowed to pay whatever the buyer believes the restaurant meal was worth. See, e.g. “Pay-what-you-like restaurants”, http://www.cnn.com/2008/TRAVEL/04/01/flex.payment/index.html (last accessed May 7, 2010). This model also is reliant upon honesty of the self-reporting, and additionally introduces a problematic self-interest factor into the self-reporting.

### BRIEF DESCRIPTION

In some illustrative embodiments disclosed herein as illustrative examples, a method comprises: presenting a plurality of sale offers for at least one item for sale to one or more buyers, the sale offers including at least one non-deterministic sale offer having a sale price and non-deterministic consideration for the sale price; conducting selling activity including the presenting and further including at least one actual sale transacted in accordance with an accepted sale offer of the plurality of sale offers; receiving buyer decision data during the conducting of selling activity; and generating buyer valuation information for the at least one item for sale based on the buyer decision data.

In some illustrative embodiments disclosed herein as illustrative examples, a method comprises: presenting a plurality of offers to one or more offerees, the offers including at least one non-deterministic offer having non-deterministic consideration for the offeree; conducting business activity including the presenting and further including at least one actual business transaction executed in response to an acceptance by an offeree of one of the plurality of offers; receiving offeree decision data during the conducting of business activity; and generating valuation information based on the offeree decision data. In some such illustrative embodiments, the method further includes generating a new offer based on the generated valuation information and conducting additional business activity including presenting the new offer. In some such illustrative embodiments, the method is performed using n offeree folds wherein the generating of a new offer for an i^{th} offeree fold is based on the generated valuation information for offeree folds other than the i^{th} offeree fold.

In some illustrative embodiments disclosed herein as illustrative examples, a method comprises: clustering offerees into n folds based on information indicative of likelihood of offeree-offeree collusion; and conducting valuation learning for each fold using valuation information obtained solely from the other (n−1) folds.

In some illustrative embodiments disclosed herein as illustrative examples, a digital processor is configured to perform a method as set forth in any one of the three immediately preceding paragraphs. In some illustrative embodiments disclosed herein as illustrative examples, a storage medium stores instructions executable on a digital processor to perform a method as set forth in any one of the three immediately preceding paragraphs.

### BRIEF DESCRIPTION OF THE DRAWINGS

FIG. 1 diagrammatically shows three illustrative censored price experiments (CPEs) employing different price points.

FIG. 2 diagrammatically shows a single “Schrödinger's Price Experiment” (SPE) that is equivalent in expected seller revenue and buyer surplus to the three CPEs of FIG. 1.

FIG. 3 diagrammatically shows a pricing system employing lotteries.

FIG. 4 diagrammatically shows a pricing optimization suitably performed by the pricing system of FIG. 3.

FIG. 5 diagrammatically shows valuation learning employing n folds to suppress or eliminate the effect of any buyer collusion in the buyer valuations used in the valuation learning.

### DETAILED DESCRIPTION

The inventors have analyzed the problem of learning optimal prices, and have developed the following. A substantial issue is the low rate of pricing information collected by conventional CPE approaches, and the low reliability of pricing information collected by “hopeful” approaches that rely upon buyer self-reporting of his or her valuation (and “hope” that the buyer is being truthful). What is desired is a pricing information collection approach that collects a large volume of pricing information in a way that filters out or biases against extreme buyer valuations.

To achieve robustness, pricing approaches disclosed herein enlarge the action space of valuation options available to buyers. However, one cannot simply provide buyers with different prices and ask the buyer to choose his or her price, as this would be susceptible to failure due to buyer dishonesty. Many (perhaps most) buyers would not choose the price that is closest to their valuation—they would simply choose the lowest offered price.

The problem can be viewed as a partially observed Markov Decision Problem (POMDP) which considers the state space to be a space of functions, known as beliefs. The pricing approaches disclosed herein consider the control space to be a space of functions, known as mechanisms or designs. Mechanisms correspond to menus of lotteries and variable lotteries. The term “lottery” as used herein refers to a non-deterministic sale offer having a sale price and non-deterministic consideration or allocation for the sale price. The consideration (or allocation) is broadly defined herein as “what is received in return for the sale price”. In a conventional purchase, the consideration is the item that is purchased. This is a deterministic consideration. Disclosed herein are techniques for employing lotteries in rapid and robust price optimization. In the case of a lottery, the consideration is non-deterministic in that what the buyer receives in return for the sale price is not fixed. For example, in an illustrative lottery the consideration comprises a chance (e.g., 60% chance) of receiving the item. In another illustrative lottery the consideration comprises receiving either item “A” or item “B” (e.g. a 60% chance of receiving item “A” and a 40% chance of receiving item “B”).

The lottery approach can be understood in terms of what is referred to herein as a “Schrödinger's Price Experiment” (SPE). A conventional censored price experiment (CPE) uses a sequence of prices. The SPE combines all these prices as a “superposition” to enable experimenting on the sequence of prices simultaneously or concurrently. The label “Schrödinger” analogizes to similar superposition experiments in quantum physics which also have non-deterministic outcomes. As already noted, however, such a superposition cannot be constructed simply by offering the buyer a set of different prices at each round, because many (possibly most) buyers would select the lowest price since that selection is in the buyer's self-interest.

However, if the lowest price only gave the item with some probability or in some other non-deterministic fashion—that is, if it corresponded to a lottery—then the buyer would select between different non-deterministic sale offers (that is, between different lotteries) without necessarily being biased by self interest toward choosing the lowest sale price. Indeed, as disclosed herein the sale prices and probabilities for the lotteries can be selected in such a way that only buyers with specific valuations will rationally prefer a given lottery. As a consequence, the SPE learns faster than a CPE because it collects data for different price points simultaneously, yet it is otherwise equivalent.

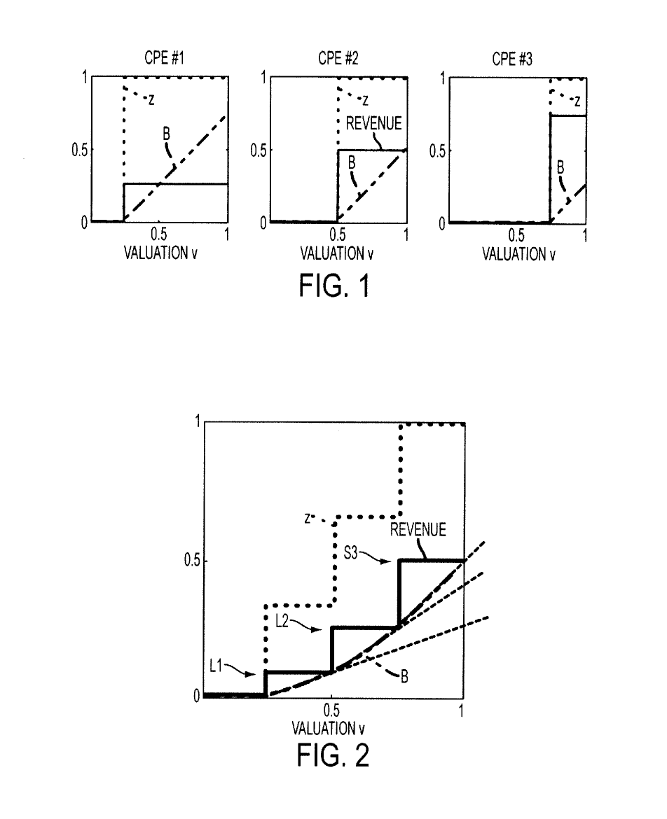

With reference to FIGS. 1 and 2, a comparison of CPE and SPE is shown. In each plot of FIG. 1, the abscissa is the buyer's valuation v, a dotted line indicates the preferred outcome probability for a buyer with this valuation (for the CPE this is always zero or one), a solid line denotes the price p that a buyer with the given valuation pays when they act in accordance with their preferences (thereby maximizing their surplus), and the dot-dashed line shows the buyer's surplus. FIG. 1 shows three illustrative CPEs. In “CPE #1”, the price is set at $0.25; in “CPE #2”, the price is set at $0.50; in “CPE #3”, the price is set at $0.75. In each case, a given sale or no-sale provides a single data range for learning, namely v≧p in the case of a buyer, or v<p in the case of a non-buyer.

FIG. 2 shows a single SPE that is equivalent in expected buyer surplus and seller revenue to the three CPEs of FIG. 1. FIG. 2 uses the same symbolism as FIG. 1, except that three prices that are denoted in FIG. 2 correspond to two lotteries L1, L2 and a deterministic sale S3, respectively. Each sale offer (that is, each lottery L1, L2 or deterministic sale S3) is denoted by labeling the sale price p, which is the revenue generated by a sale. In the first lottery L1 the sale price p=$ 1/12, but the non-deterministic consideration has an associated probability z=⅓, so that the “effective” price is p/z=$0.25. The second lottery L2 and the deterministic sale S3 have increasingly higher sale prices and increasingly higher associated probabilities (p=1 in the case of the deterministic sale S3), and hence increasingly higher “effective” prices p/z. The buyer's surplus in these cases is also modified by the probability z so that the buyer's surplus is given by vz−p, reflecting the (probabilistic or statistical) valuation of the non-deterministic consideration received in compensation for paying the sale price. By suitable selection of the sale price and probability for each lottery, the valuation vz−p can be made to be continuous and piecewise linear with the linear segments of increasingly larger slope for higher (effective) price.

As a result, a rational buyer will find that one of the three sale offers L1, L2, S3 provides an optimal buyer's surplus as compared with the other sale offers. This is emphasized in FIG. 2 by showing the three (non-zero) buyer's surplus lines for the three lotteries each extended by a dotted line to greater than v=1. For buyers with any valuation excepting v=$0.25, $0.5 or $0.75 precisely, the only rational selections are as follows: for v<$0.25, the buyer makes no purchase because none of the sale offers L11, L2, 53 provide a positive buyer's surplus; for $0.25≦v<$0.50 the first lottery L1 is selected because only the first lottery provides the buyer with a positive buyer's surplus; for $0.50<v<$0.75 the second lottery L2 is selected because although both the first and second lotteries L1, L2 provide a positive buyer's surplus the second lottery L2 provides a larger buyer's surplus; and finally for v≧$0.75 the deterministic sale S3 is selected because it provides the largest buyer's surplus (although for this valuation range all three sale offers L1, L2, S3 provide a positive buyer's surplus).

An illustrative example is given next for computing the sale price p and probability z for a case involving two lotteries, which is equivalent to two CPE, namely a first CPE that sets a sale price v₁ on n₁ days, and a second CPE that sets a sale price v₂ on n₂ days. A corresponding SPE would include a first lottery having a sale price

$$\frac{{n}_{1}}{n} {v}_{1}$$

for probability

$$\frac{{n}_{1}}{n}$$

of receiving the item, and a second lottery having a sale price

$$\frac{{n}_{1}}{n} {v}_{1} + \frac{{n}_{2}}{n} {v}_{2}$$

for probability 1 of receiving the item. In these expressions n:=n₁+n₂. Imagine that buyers have valuation lower than v₁ with probability 1−q₁−q₂, valuations in [v₁, v₂) with probability q₁ and valuations in [v₂,∞) with probability q₂. These probabilities are unknown to the seller. The expected profit (assuming zero seller cost, although a non-zero seller cost is readily accommodated by a shift in valuations) is (q₁+q₂)v₁n₁+q₂v₂n₂ for the CPE, and is

$$n ( {q}_{1} \frac{{n}_{1}}{n} {v}_{1} + {q}_{2} ( \frac{{n}_{1}}{n} {v}_{1} + \frac{{n}_{2}}{n} {v}_{2} ) )$$

for the SPE. It is readily verified that these are equivalent. However, in the case of the CPE, when the sale price v₂ is rejected by a buyer, the CPE does not know if this was due to the buyer having a valuation that is lower than v₁, or is due to the buyer having a valuation in the range [v₁, v₂). In contrast, the SPE distinguishes these cases. While the foregoing lottery example tests two valuations v₁ and v₂, extension to three, four, or more valuations is straightforward through the use of additional lotteries. In general, a lottery for a single-item problem includes a non-deterministic sale offer in which the non-deterministic consideration is a probabilistic consideration having a probability P of receiving the item and a probability (1−P) of not receiving the item.

The lottery approach can also address two, three, four, or more (in general, N) items for sale. Some of the N items may be mutually exclusive such that purchase of one item precludes purchase of another item. For example, if the items for sale are different brands of toothpaste, then (at least in many cases) the purchase of one brand of toothpaste will preclude the buyer from purchasing another brand of toothpaste at the same time. In the case of N such “mutually exclusive” items (where N is at least two), the non-deterministic consideration of the non-deterministic sale offer defining the lottery is suitably constructed as receipt of one of the N items, with the item received determined probabilistically. One or more such lotteries can be used to determine (in this example) the optimal sale price for each different brand of toothpaste.

More generally, in the case of a multi-item problem the lotteries can be optimized to identify an optimal sale offer which may, in general, itself be a lottery. By way of illustrative example, in the marketing of two brands A and B of toothpaste, if the (average) buyer does not particularly prefer either brand A or brand B, then the optimal sale offer may be a lottery having a discounted sale price (as compared with a deterministic sale of brand A or a deterministic sale of brand B) for which the consideration is a 50% likelihood of receiving brand A and a 50% likelihood of receiving brand B.

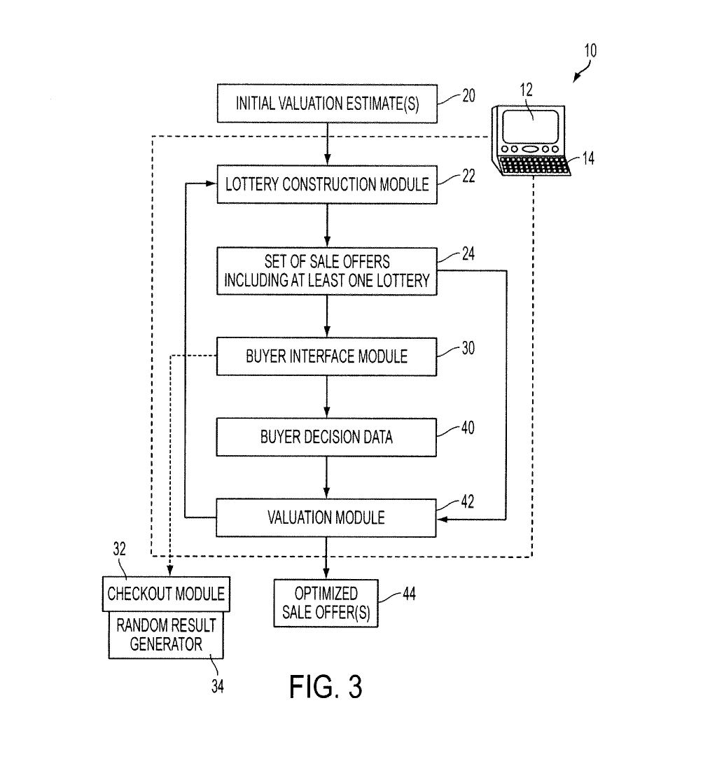

With reference to FIG. 3, an illustrative pricing system employing pricing optimization via lotteries is described. Because the construction of lotteries and the determination of estimates of the distribution of valuations based on lottery results is computationally intensive, the disclosed pricing system is computer-based, in the illustrative example being implemented using an illustrative computer 10 having user interfacing devices such as an illustrative display 12 and an illustrative keyboard 14. The illustrative computer 10 is a personal computer, such as a desktop computer or a laptop computer. However, in other embodiments the computer and associated components may be otherwise configured. For example, in the case of Internet-based marketing, the computational components of the pricing system may reside on a suitable server computer that is in wired or wireless connection with the Internet, and a buyer may interact with the server computer via any Internet-capable device such as a computer, cellular telephone, personal data assistant (PDA), tablet (e.g., an iPad™ available from Apple Corporation, Cupertino, Calif., USA), or so forth.

With continuing reference to FIG. 3, to initiate the lottery-based pricing process, the seller provides an initial belief over possible valuation distributions 20. This belief over valuation distributions is suitably the same as might be chosen for a set of CPE experiments. More generally, the belief over valuation distributions may be chosen on the basis of diverse factors. For example, because the pricing process is performed concurrently with actual selling of the products, the initial valuation estimates 20 should be high enough that the seller has some sales revenue (that is, not selling at a loss), but should not be so high that the price results in few or no sales. In general, the valuation distribution alone does not determine the price. The seller cost also determines the mechanism offered (e.g. prices)—if the objective is profit for the seller then no reasonable mechanism design would offer below-cost consideration or allocations, since then the seller would lose money. Moreover, the approaches disclosed herein are not limited to the application of seller profit maximization, but rather can also be applied for optimizing respective to other goals, such as maximizing buyer welfare (e.g. the sum of buyers' valuations) or optimizing loading on product suppliers or internal supply lines. The optimization can be respective to a combination of objectives: by way of illustrative example, an optimization that maximizes a sum (or other balancing) of buyer welfare (i.e., surplus) and seller profit. Such an optimization balancing seller profit and buyer welfare is suitable, for example, in the case of healthcare products. Given that human valuation distributions may be complex, due to the range of outside options, budget constraints and a heterogeneous population of buyers, it is advantageous for the belief over the valuation distribution to be flexible in terms of what valuation distributions it can represent. In some embodiments, the initial belief may be chosen by a programmer and a cooperating salesperson without mutual knowledge and understanding of each other: for instance, the programmer might not understand the salesperson's appreciation of a product, while the salesperson might not understand computations with probability density functions.

A lottery construction module 22 generates a plurality of sale offers for the one or more items for sale. At least one of the sale offers should be a lottery, that is, a non-deterministic sale offer having a sale price and non-deterministic consideration for the sale price. As already described, for example with reference to FIG. 2, the sale offers should also be selected such that only buyers with specific valuations will rationally prefer a given lottery. Said another way, for a given valuation there should be one sale offer (or, at most a definable sub-set of the total plurality of sale offers that does not greatly intersect with other available sub-sets) that provides the highest buyer's surplus (in the stochastic sense of expectation over future outcomes). The output of the lottery construction module 22 is a set of sale offers 24 including at least one lottery. It should be noted that not all sale offers of the set of sale offers 24 are necessarily lotteries. For example, one or more of the sale offers may be a deterministic sale offer, e.g. a set sale price that yields as (definite) consideration a particular item.

Once the set of sale offers 24 is established, the “Schrödinger's Price Experiment” (SPE) is carried out by a buyer interface module 30, which presents a buyer with the set of sale offers 24 including at least one lottery that is offered at least at one time instant. It is to be understood that the buyer interface module 30 engages in actual selling using the set of sale offers 24 as genuine offers for sale. The illustrative example of FIG. 3 is an Internet-based selling, for which the buyer interface module 30 is suitably a retailer (or, more generally, seller's) website that presents the set of sale offers 24 to a customer. If the buyer accepts a sale offer, then this is an actual sale which is implemented by a checkout module 32 which carries out the transaction. Again, for the illustrative Internet-based marketing system of FIG. 3, the checkout module 32 is computer-implemented and employs a suitable Internet-based approach for collecting the sale price and conveying the purchased item to the purchaser. For example, the sale price may be collected using a credit card number, a Paypal™ account (available at https://www.paypal.com/, last accessed May 10, 2010), or so forth, and the item delivery is suitably implemented by electronic contracting with a commercial shipping company.

In the case of a transaction in which the accepted sale offer is a lottery (that is, the accepted sale offer is a non-deterministic sale offer in which the return for the sale price is non-deterministic consideration), the checkout module 32 suitably includes or has access to a random result generator 34. (As is conventional in the art, the term “random result generator” as used herein includes both true random number generators and “pseudorandom number generators”, for example a processor implementing a pseudorandom number generation algorithm in which the output is actually deterministic but has sufficient complexity, and a distribution approximating a random number distribution, so as to appear to be random and to well approximate a given distribution of random numbers). For example, if the accepted sale offer is a single-item lottery in which the consideration is a 30% chance of receiving the item, then the checkout module 32 suitably evaluates result=0.3*R where R is a random (encompassing pseudorandom) number generated by a random (encompassing pseudorandom) result generator implementing a uniform or constant probability density function over the range [0,1). If result is less than or equal to 0.3 then the buyer “wins the lottery”, and the item is shipped to the buyer. On the other hand, if result is greater than 0.3 then the buyer “loses the lottery” and the item is not shipped to the buyer. In either case, the checkout module 32 suitably informs the buyer whether or not the buyer “won the lottery”, that is, whether or not the buyer will be receiving the item. Preferably, this information is provided to the buyer as a purchase receipt, and is preferably also stored in a persistent repository (not shown) owned by the seller. The persistent repository provides data for tax purposes, and for tracking performance of the checkout module 32 to ensure and verify that the checkout module 32 is providing “fair” lottery results in a statistical sense.

Operation of the checkout module 32 ensures that buyer decisions are “real” decisions that have real-world consequences for the buyer. This, in turn, ensures that the buyer acceptance/rejection data 40 collected by the buyer interface module 30 accurately reflects real-world buyer decisions that inform about buyer valuation. As already noted, the checkout module 32 also engages in actual selling of items, and so generates a continuing revenue stream for the seller during the pricing optimization process. A valuation module 40 processes the buyer acceptance/rejection data 42 to determine a distribution of buyer valuations indicated by actual purchases. (More generally, given covariates on buyer valuations, the valuation module 40 may in some embodiments process the buyer acceptance/rejection data 42 to determine a family of distributions over buyer valuations, which itself may vary with time.)

With continuing reference to FIG. 3 and with brief returning reference to FIG. 2, by way of example a sale of lottery L2 indicates that the buyer valuated the product in the range 0.5≦v<0.75. On the other hand, a sale of lottery L1 indicates that the buyer valuated the product in the range 0.25≦v<0.50. A “no sale” indicates the buyer valuated the product at v<0.25. A sale of lottery L3 indicates that the buyer valuated the product at v>0.75. (The foregoing assumes that the buyer was not deviating from their true selfish interest.)

The valuation distribution information output by the valuation module 42 can be used in various ways. One approach is to use this valuation distribution information as feedback supplied to the lottery construction module 22, which can then construct refine the set of sale offers 24 and repeat the process to further refine the estimated valuation distribution. This can be repeated cyclically to refine the estimated valuation distribution. The cycle can be repeated after each buyer makes a decision, or after a selected number of buyers make decisions. The final result (either with or without iteration) is a set of one or more optimized sale offer(s) 44 for the product. If iteration is employed, it is expected that the iterations for a single-item problem will ultimately converge to a final discrete sale price for the item. In the case of a multiple-item problem the convergence may be to final discrete sale prices for the respective (multiple) items, or the convergence may be to an optimized menu of lotteries.

In FIG. 3 which illustrates an Internet-based price-optimization system, the system is substantially completely automated. In other applications, certain operations may be manual, that is, performed by a human seller. For example, the buyer interface module 30 may in some embodiments be replaced by a human seller who presents the set of sale offers 24 to the buyer, for example in the context of a product showroom, or in an on-site sales visit, or in responses to a request for proposals or so forth. In such embodiments, the checkout module 32 may optionally also be replaced by human action, for example by a human salesperson or team of salespeople closing the sale. In such embodiments, the random result generator 34 may continue to be a computer-based random result generator, or may use a suitable mechanical random result generator such as one or more dice.

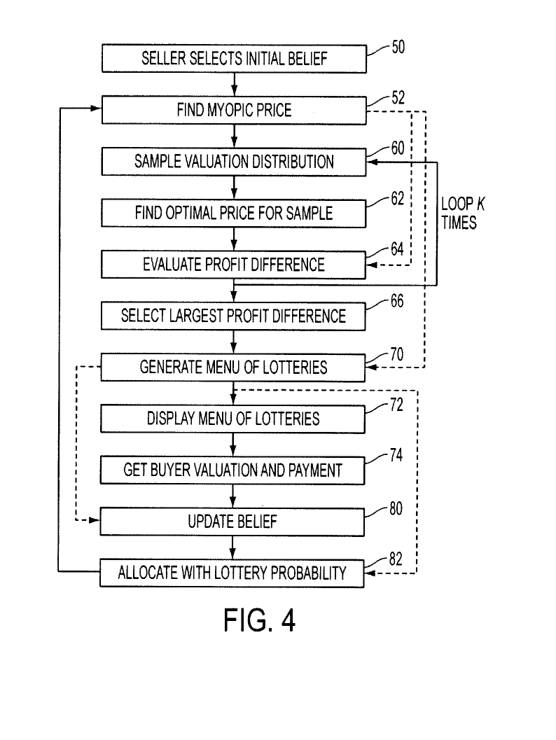

With reference to FIG. 4, operation of the lottery-based price optimization is further described. Initially, the seller has a belief over buyers' valuation distributions. This is represented in FIG. 4 by an operation 50 in which the seller selects the initial belief, and an operation 52 in which this belief is used to set an initial price. In FIG. 4, the selected price is a “myopic” price, that is, a price selected for immediate value and therefore non-strategic and non-learning). The operations 50, 52 of FIG. 4 correspond with the initial valuation estimate(s) 20 of FIG. 3. The following process then repeats: (1) Experimental Design (FIG. 4 operations 60, 62, 64, 66, 70, 72): The seller proposes some lotteries for some items, where some of the non-deterministic lotteries are chosen in order to learn about buyer values; (2) Observation (FIG. 4 operation 74): A current buyer selects from those lotteries on the basis of their private values for the items; and (3) Belief Update (FIG. 4 operation 80): The seller updates the lotteries offered to another buyer on the basis of the current buyer's selection between lotteries. FIG. 4 operations 60, 62, 64, 66 are suitably performed by the lottery construction module 22 of the system of FIG. 3. FIG. 4 operations 70, 72, 74 are suitably performed by the buyer interface module 30 of the system of FIG. 3. FIG. 4 operation 80 is suitably performed by the valuation module 42 of the system of FIG. 3. Additionally, FIG. 4 diagrammatically indicates an “allocation with lottery probability” operation 82 which suitably corresponds to the checkout process performed by the checkout module 32 of FIG. 3.

With continuing reference to FIG. 4, some illustrative examples of the process are set forth. The operations 50, 52 of FIG. 4 relating to the valuation and belief model are first addressed. In the illustrative examples, the buyers' valuations are assumed to be multinomial—thus any discrete distribution can be modeled. Without loss of generality, the buyer's valuations are assumed to be one-dimensional on a uniformly spaced grid, and the seller is assumed to have a Dirichlet belief over the parameters of the multinomial.

To quantify the illustrative example, the valuations are drawn from a multinomial distribution over a set V:=(v₁, v₂, . . . , v_{N}). The assumption of a known finite set of valuations can in some cases be motivated by a discretization of the space of monetary units. The multinomial has parameter vector θ={θ₁, . . . , θ_{N}} with Σᵢ₌₁^{N}θᵢ=1. A buyer is understood to have valuation vₖ with probability θₖ.

While the set of possible valuations V is known, the probabilities θ of observing particular values is not known perfectly to the seller. A Dirichlet distribution is taken as the assumed density (i.e. representation of the seller's belief about the parameters of the multinomial) in the illustrative examples. The Dirichlet distribution is sufficiently general to allow any specific valuation probabilities θ and is thus known as a non-parametric prior. Choosing such a distribution makes much sense as real-world valuation distributions are known to be rather complex, involving sharp transitions from budget constraints and competing outside options.

At time step t=0 the seller's Dirichlet belief is given by parameters α={α₁, . . . , α_{N}} with αᵢ>0. The corresponding probability density function over possible valuation distributions is:

$$ℙ ( θ ) := Dir ( θ ; α ) = \frac{Γ ( {α}_{1} + … + {α}_{N} )}{Γ ( {α}_{1} ) … Γ ( {α}_{N} )} {θ}_{1}^{{α}_{1} - 1} … {θ}_{N}^{{α}_{N} - 1} .$$

The Dirichlet distribution is conjugate to the multinomial. Therefore computing posteriors [symbol] (θ|vᵢ) after fully-observing a buyer's value vᵢ is easy. The result is another Dirichlet with parameters α′:=α+eᵢ where eᵢ is a shorthand for a vector of length N with a 1 at position i and zeros everywhere else. That is:

$$ℙ ( θ \vert {v}_{i} ) = \frac{Γ ( {α}_{1} + … + {α}_{N} + 1 )}{Γ ( {α}_{1} ) … Γ ( {α}_{i} + 1 ) … Γ ( {α}_{N} )} {θ}_{1}^{{α}_{1} - 1} … {θ}_{i}^{{α}_{i}} … {θ}_{N}^{{α}_{N} - 1} .$$

The experimental design is next addressed by way of illustrative example. This corresponds to FIG. 4 operations 60, 62, 64, 66, 70, 72, in which the seller proposes some lotteries for some items, where some of the non-deterministic lotteries are chosen in order to learn about buyer values. These operations create a menu of lotteries that: (i) is as myopic as possible, as this maximizes profit; (ii) simultaneously explores alternative prices that might result in more profit than the myopic optimum; and (iii) ensures that observations can be believed given that a buyer may be a liar.

To trade-off exploration and exploitation, in the illustrative examples an approach is adopted that is similar to the best of sampled sets (BOSS) method of Asmuth et al (2009). J. Asmuth et al., “A Bayesian Sampling Approach to Exploration in Reinforcement Learning”, 25th UAI, pp. 19-26, 2009. BOSS drives exploration by sampling multiple models from the posterior belief and selecting actions optimistically.

Multiple multinomial models of buyer valuations are sampled from the Dirichlet posterior belief, as per operation 60. For each sample, the profit-maximizing price and the corresponding expected profit on the sampled valuation distribution are identified, as per operations 62, 64. Some samples have a high expected profit on their valuation distribution relative to the expected profit of the myopic-optimal price on the current posterior. This could happen in two ways. Firstly, because the sampled valuation distribution has more buyers just above the myopic-optimal price. In this case, the myopic price would also perform well. Secondly, because the price is substantially different from the myopic-optimal. In this case, the myopic price is rather risky and it is imperative to explore the alternative price. Accordingly, in the illustrative examples a sample is considered to be “optimistic” if the expectation on the sample's valuation distribution of the difference between the profit for the sample's optimal price and the profit for the myopic-optimal price is large. Note that an optimistic sample could correspond to a price that is higher, lower or equivalent to the myopic-optimal price.

For simplicity, the illustrative examples mix just one optimistic price with the myopic-optimal price. The resulting menu of lotteries will then have two or three market segments, that is, sets of valuations, where all buyers in each segment will receive the same lottery probability and price. The highest value segment will receive the item with probability one and the lowest segment will receive the item with probability zero. The intermediate segment, when there is one, will receive the item non-deterministically. To ensure that observations are robust to liars, it is ensured that any buyer wishing to select a lottery other than that which maximizes their surplus will lose at least ε of that surplus. This is referred to as ε-incentive compatibility. For the assumptions above, this means that the buyer will decide not to lie.

Given the myopic-optimum price vₘ and the optimistic price vᵤ, in the operation 66 the problem is to find profit-maximizing lotteries such that we can distinguish between values in the segments [0, vₘ), [vₘ, vᵤ), [vᵤ, ∞) or in the segments [0, vᵤ), [vᵤ, vₘ), [vₘ, ∞) with ε-incentive compatibility. For the sake of obtaining simple formulae, in the illustrative examples it is assumed that

$$ε = \frac{Δ v}{12}$$

where Δv is the spacing between successive valuations in the Dirichlet model. This problem turns out to be a linear program (LP). By observing which constraints should be active, it is straightforward to find a closed-form solution to this LP. In the upper segment the lottery has probability 1. The rest of the solution is parameterized as follows: in the middle segment the lottery probability is z; in the interval with lowest valuation vᵤ, the price is pᵤ; and in the interval with lowest valuation vₘ, the price is pₘ. The solution is then:

$${v}_{m} < {v}_{u} ⇒ z = \frac{5}{6} , {p}_{m} = \frac{10 {v}_{m} - Δ v}{12} , {p}_{u} = \frac{{v}_{u} + 5 {v}_{m} - Δ v}{6}$$

$${v}_{u} < {v}_{m} ⇒ z = \frac{1}{6} , {p}_{m} = \frac{{v}_{u} + 5 {v}_{m} - Δ v}{6} , {p}_{u} = \frac{2 {v}_{u} - Δ v}{12}$$

$${v}_{u} = {v}_{m} ⇒ {p}_{u} = {p}_{m} = {v}_{u} - \frac{Δ v}{12} .$$

In summary the steps of the experimental design are: (i) Given belief hyperparameters a over the parameters 61 of the valuation distribution, (ii) Find the myopic-optimal price p* for the current belief, (iii) Sample K parameter vectors θ₁, . . . , θ_{K} from the current belief (K=5 is used in some illustrative examples herein), (iv) For each sample θₖ solve for the optimal price pₖ, (v) Evaluate the profits πₖ and πₖ*, for this optimal price and for the myopic-optimal price on this sample, (vi) Select an optimistic price with index k satisfying πₖ−πₖ*≧πⱼ−πⱼ* for all j≠k, and (vii) Obtain the menu of lotteries for valuations vᵤ=pₖ, vₘ=p* using the formulae given immediately above.

It is noted that the foregoing differs substantially from conventional BOSS. For example, BOSS attempts to solve general Markov Decision Problems (MDPs), and accordingly BOSS selects actions from different models in different observable states. That step is not employed herein, as the system is assumed herein to be always essentially in just one “observable state” corresponding to the multinomial distribution being fixed rather than time-varying. Another difference is that BOSS selects a single action at each state, whereas in the illustrative approaches disclosed herein several are selected to be explored in parallel. In some illustrative examples, two actions are selected: the myopic action and the optimistic action. Yet another difference is that BOSS defines an “optimistic” action as one that maximizes expected discounted reward when all possible sampled models of the world can be chosen from, whereas the illustrative examples herein define an optimistic action as one that maximizes expected welfare or profit on a sample relative to the welfare or profit that the myopic action would attain on that sample.

While the above description of the selection of the myopic and optimistic prices used the words “profit” or “welfare”, these terms were for simplicity of exposition. It is also contemplated for the buyer's objective in selecting the myopic and optimistic prices to reflect some weighted linear combination of seller profit and buyer surplus, where the weight for either part of the combination is significantly non-zero. On the one hand, the seller would be “squeezing” their buyers; on the other hand, the seller would have to “squeeze” their suppliers. Both extremes may be undesirable in various applications. In some complex real-world settings, a weighted linear combination of profit and welfare may be achievable. See, e.g. K. Roberts, “The characterization of implementable choice rules”, in Jean-Jacques Laffont, editor, Aggregation and Revelation of Preferences. Papers presented at the 1st European Summer Workshop of the Econometric Society, pages 321-349. North-Holland, 1979.

The belief update is next addressed by way of illustrative example. This corresponds to FIG. 4 operation 80, in which the seller updates the lotteries offered to another buyer on the basis of the current buyer's selection between lotteries. Any observed valuation vₒ is considered as a censored observation of the region of valuations:

R(v₀,ε):={v:w(v,vₒ)≧w(v,v)−ε},

where w(a,b) is the surplus of a buyer who has valuation a but lies that their valuation is b. For any observation, this corresponds to one of the two or three segments generated in the experimental design.

We lose conjugacy to the Dirichlet density in the case that vᵢ is not directly observed but instead is known to come from set S⊂V. In this case, the exact posterior is a mixture of Dirichlet's (MoD). To see this, consider that Bayes's rule gives:

$$ℙ ( θ \vert v ∈ S ) = \frac{ℙ ( θ , v ∈ S )}{ℙ ( v ∈ S )} = {\sum }_{i ∈ S} ℙ ( θ \vert {v}_{i} ) \frac{ℙ ( {v}_{i} )}{{\sum }_{j ∈ S} ℙ ( {v}_{j} )} .$$

After T censored observations with censoring set Sₜ at time t there may be many components to this mixture. This not computationally tractable.

If it is desired for the belief to remain in some simple family, one could apply assumed density filtering (ADF) or expectation propagation (EP), as described, for example, in: Minka, “Expectation Propagation for Approximate Bayesian Inference”, Proc. 17^{th} Annual Conf. Uncertainty in Artificial Intelligence (2001); Minka, “A family of algorithms for approximate Bayesian inference”, PhD Thesis, MIT (2001); and T. Heskes, and O. Zoeter, “Expectation Propagation for Approximate Inference in Dynamic Bayesian Networks”, Proc. 18^{th} Annual Conf. Uncertainty in Artificial Intelligence (2002). ADF computes the posterior after each observation and then updates the posterior by projecting it in the sense of minimum Kullback-Leibler divergence, into the simple family of beliefs.

If the different mixture components are close to each other, the mixture of Dirichlet's (MoD) posterior may be well-approximated by a single Dirichlet distribution. For instance, the MoD posterior is suitably projected onto a single Dirichlet by the standard Kullback-Leibler (KL) projection. For probability densities from exponential families, the best matching approximation in the KL sense is one that matches so-called natural moments. The natural moments for the Dirichlet are [symbol] log θᵢ.

To construct such approximations, a link function is suitably used. A link function informs as to the expected natural moments for a given set of parameters. It is thus generally a mapping from a parameter vector to a moment vector. The inverse of the link function informs as to what the parameter values should be if the natural moments are to have some specific values. The link function for the Dirichlet is:

$$[ {g}_{i} ( α ) ] := [ {𝔼}_{ℙ ( θ \vert α )} log {θ}_{i} ] = [ \begin{matrix}ψ ( {α}_{1} ) - ψ ( {α}_{0} ) \\ ⋮ \\ ψ ( {α}_{N} ) - ψ ( {α}_{0} )\end{matrix} ] , {α}_{0} := {\sum }_{i = 1}^{N} {α}_{i} ,$$

where ψ is the digamma function,

$$ψ ( z ) := \frac{d log Γ ( z )}{d z} .$$

Thus, to find a best-approximating set of Dirichlet parameters α′ to a MoD with probability density function [symbol] (θ) it is sufficient to compute

α′=g⁻¹( [symbol] _{θ˜} [symbol] log θ)

where log θ is an abbreviation for the vector with components log θ₁, . . . , log θ_{N}. Often there is no closed form for the inverse link function or for the expected natural moments. Fortunately, for a MoD, the expected natural moments are simply the weighted combination of the natural moments of the individual Dirichlets making up the mixture.

Determination of the inverse link function is next addressed. For the Dirichlet updates, the expression to be solved is:

$${𝔼}_{θ \sim M} log {θ}_{i} \text{=} \text{:} {M}_{i} = ψ ( {α}_{i} ) - ψ ( {α}_{0} ) , {α}_{0} := {\sum }_{i = 1}^{N} {α}_{i} .$$

Putting x:=ψ(α₀) shows that the only nontrivial part of this problem is the root-finding problem:

$$f ( x ) := ψ ( {\sum }_{i = 1}^{N} {ψ}^{- 1} ( {M}_{i} + x ) ) - x = 0.$$

While this is a single non-linear equation, it involves inverse digamma functions, for which rational or spline approximants can be approximated. As an alternative solution, a direct application of Newton's method to the full set of equations using sparse matrix operations is highly efficient.

The foregoing assumes that buyers operate in their self-interest, and (since they are engaged in actual purchases) do not “lie” in their valuations. However, the analysis can also be adapted to allow for buyers to “lie”, that is, to set forth valuations that are not in accord with the buyer's internal belief. This is quantified as follows: each buyer may be a liar who is willing to lose an amount of their surplus in order to fool a mechanism.

The foregoing description relates to embodiments relating to selling, with optimization of buyers' welfare, seller's profit, or a linear weighted mixture of these objectives, or so forth. More generally, the disclosed approaches involving superpositions can also be readily applied to procurement, to repeated auctions with a reserve price which might be varied, to a variety of repeated exchange scenarios such as double auctions (markets), to purchases immediately involving multiple parties and to “multi-sided markets” (also known as “platforms” where the seller sets a price to multiple parties, as when a credit card firm makes charges to both card owners and shops that accept the credit card). In the case of repeated procurement, a buyer may wish to purchase an item at a sequence of times for a reasonably low price. The buyer may not be in a suitable situation to identify precisely what a reasonably low price is for certain kinds of items. Rather than posting a guess for the highest price that the buyer is willing to pay, the buyer may attempt to learn about the distribution of sellers' costs or of sellers' outside options. In this case, a cost may be considered as a negative valuation and the arguments disclosed above apply. For instance, in the analogue of a CPE, the buyer may post a purchase price of $1 for one week and a purchase price of $2 for a second week. Using the analogous SPE the buyer would post a purchase price of $ 3/2 for a purchase of the item with probability 1 and a price of $1 for a purchase with probability ½. The non-deterministic situation might be implemented as the buyer paying $1 and subsequently, on sharing a random variable distributed as a Bernoulli variable with probability ½, deciding to receive the purchase or to not receive the purchase. Analogously to the use of the SPE for selling, the SPE for purchasing preserves the buyer's surplus and the seller's profit that would be achieved via a CPE, but it is, advantageously, possible to learn faster with an SPE than with a CPE.

To generalize, in the disclosed approaches an offeror presents a plurality of offers to one or more offerees, the offers including at least one non-deterministic offer having non-deterministic consideration for the offeree. The offeror receives decision data responsive to the presenting, and generates offeree valuation information based on the decision data. The offeror may then present a new offer based on the generated offeree valuation information. In the illustrative case, the offeror is the seller and the offeree is the buyer; however, in a procurement application the offeror may be the buyer who makes various offers to purchase a product at various purchase prices, at least one of which is a lottery in which the price paid is non-deterministic, and the offeree may be a seller who accepts or rejects the offer.

The disclosed pricing and consideration optimization employing lotteries is learned on buyer decision data respective to the sale offers. More generally, substantially any pricing optimization approach will ultimately entail such learning based on buyer decision data. (Indeed, even sellers who simply make a single decision about what price to offer for a single item still do so on the basis of past sales decisions by buyers for other items). This is inherent because ultimately the valuation of an item offered for sale is determined by the valuation placed on that item by buyers. One can attempt to estimate the buyer valuation by various approaches (e.g., computing a manufacturing, transportation or servicing cost and adding a predetermined profit margin, comparison with valuations of similar products, or so forth), but the valuation ultimately is controlled by what buyers are willing to pay.

In some suitable approaches disclosed herein, the learning of the optimal pricing employs partitioning of the set of buyers into folds, where each fold maintains a belief about all the other folds and this belief is used to select learning mechanisms for the buyers contained in it. As disclosed herein, folds make the learning mechanism truly incentive compatible in cases where buyers may make multiple purchases. It is disclosed herein that having few folds makes belief maintenance computationally efficient, and can also reduce the risk of collusion amongst buyers.

The disclosed use of folds in the learning is motivated by the following observations. If a buyer believes that future prices that the buyer receives will increase with any valuations that he or she expresses to a valuation learning mechanism, then it can be in the buyer's interest to express lower than truthful valuations, although there are some sellers' beliefs for which a buyer expressing a lower-than-truthful valuation makes prices go up rather than down. This problem can be avoided by ensuring that prices for one buyer only depend on valuations expressed by other buyers. However, in settings with large numbers of buyers, maintaining a separate belief for each buyer is computationally demanding, incurring a computational cost that is in some instances quadratic in the number of buyers. A further issue is that some buyers may be known to be more likely to collude with other buyers. It is desired to reduce the impact of such collusion.

In pattern recognition, folds are sometimes employed for estimating generalization performance of classifiers. For example, in the method of n-fold cross-validation, the data set is partitioned into n sets. A classifier is trained at times t=1, . . . , n. At time t all data other than set t is used for training and set t is then used for testing. The test results are then averaged. If n equals the size of the dataset, the method is known as the jackknife. Typically smaller n=10 is used for computational convenience.

It is recognized herein that maintaining a separate belief for each buyer is directly analogous to the jackknife. For computational convenience, in some illustrative examples of the disclosed fold-based valuation learning, buyers are partitioned into n=10 “folds” and only one belief is maintained per fold. A fold's belief is based only on information from other folds and is used to set prices or choose mechanisms for buyers in that fold.

In some embodiments, rather than partitioning into folds purely randomly, some side-information is utilized that assigns a probability of collusion to each pair of buyers. For example, this side information may be based on family, geographical location or other social-network information that suggests collusion may be likely. Given a target number of folds, minimizing the total probability of collusion then corresponds to a clustering problem, which can be solved using substantially any known clustering method. The disclosed folds-based learning approaches advantageously facilitate pricing optimization or experimentation that is incentive compatible, yet computationally efficient.

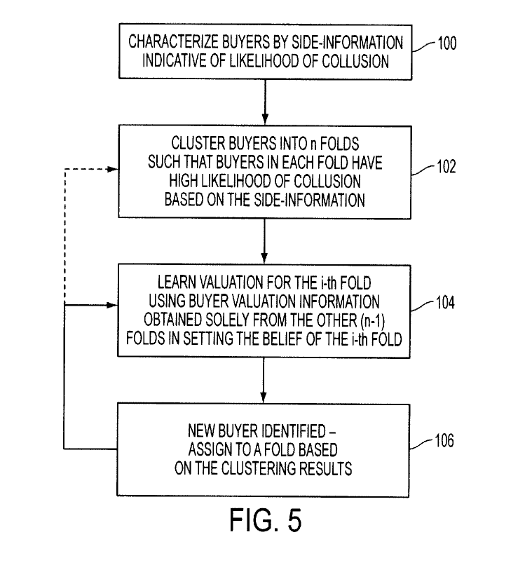

With reference to FIG. 5, a suitable approach for learning valuation information using folds is described. In an operation 100, an initial set of buyers is characterized by side-information that is indicative of a likelihood of collusion. For example, the side information may operate in a pairwise fashion to identify likelihood of collusion between a pair of buyers. As an example, if information is available about links of each buyer in a social networking site, then the side information for a pair of buyers (a,b) may be computed as L+N_{CL}/N_{Ta}+N_{CL}/N_{Tb} where L=1 if buyers (a,b) are linked with each other, N_{CL} is a count of the number of links that are common for both buyers (a,b), N_{Ta} is a count of the total number of links to buyer (a), and N_{Tb} is a count of the total number of links to buyer (b). In another example, the side information for a pair of buyers (a,b) may be computed as the geographical distance between any recorded addresses of buyers (a,b). These are merely illustrative examples of side information that may be indicative of likelihood of collusion.

In an operation 102, the buyers are clustered into n folds based on the side information. The clustering groups together buyers that are likely to collude, while placing buyers that are unlikely to collude into different folds. Some suitable clustering approaches that operate on pairwise “similarity” data (where a pair of buyers who are likely to collude are considered to be “similar” while a pair of buyers who are unlikely to collude are considered to be dissimilar) include K-means clustering, spectral clustering, or so forth. The purpose of the clustering operation 102 is to ensure that (i) each fold includes buyers who are likely to collude with each other and (ii) buyers in different folds are unlikely to collude with each other.

In an operation 104, the learning of valuation distributions is performed on a per-fold basis. Valuation learning for the i-th fold is performed using buyer valuation information obtained solely from the other (n−1) folds in setting the belief of the i-th fold. For example, in the illustrative example of learning by lottery as set forth in FIGS. 3 and 4 herein, the lottery construction module 22 generates the set of sale offers (including at least one lottery) 24 for the i-th fold using buyer decision data 40 (and valuation data derived therefrom by the valuation module 42) generated by the other (n−1) folds. The advantage of this approach is that any collusion between buyers in the i-th fold does not affect the belief (which in this example is represented by the set of sale offers 24) for the i-th fold, because that belief is determined only from buyer decision data collected from the other (n−1) folds.

In an operation 106, it is contemplated that a new buyer may be identified during the valuation learning, who was not one of the buyers processed in the clustering operation 102. In such a case, the operation 106 characterizes the new buyer, for example using the characterization operation 100, and assigns the new buyer to a fold that is the best fit for the characterization of the new buyer while balancing the relative sizes of the folds to ensure computational tractability. Alternatively, or if the number of new buyers becomes too large, the clustering operation 102 may be repeated to generate wholly new sets of clusters.

In the illustrative examples, the valuation learning operation 104 employs a learning by lottery approach as disclosed herein. More generally, however, substantially any valuation learning algorithm can be employed, with the fold approach advantageously ensuring incentive-compatibility, or reducing or eliminating the effect of any collusion between buyers.

Moreover, the fold-based learning of FIG. 5 is readily extended to fold-based valuation learning conducted by sellers (as illustrated in FIG. 5) or by buyers (for example, in procurement settings). In the latter case, potential sellers (i.e., suppliers) are characterized based on side information indicative of likelihood of collusion and clustered into n folds such that sellers (i.e., suppliers) in each fold have a high likelihood of collusion based on the side information. To generalize, offerees are characterized based on side information indicative of likelihood of collusion and clustered into n folds such that offerees in each fold have a high likelihood of collusion based on the side information.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method comprising:
presenting a plurality of sale offers for at least one item for sale to one or more buyers, the sale offers including at least one non-deterministic sale offer having a sale price and non-deterministic consideration for the sale price;
conducting selling activity including the presenting and further including at least one actual sale transacted in accordance with an accepted sale offer of the plurality of sale offers;
receiving buyer decision data during the conducting of selling activity; and
generating buyer valuation information for the at least one item for sale based on the buyer decision data.

2. The method as set forth in claim 1, further comprising:
generating a new sale offer including a new sale price for the at least one item determined based on the generated buyer valuation information; and
conducting additional selling activity including presenting the new sale offer.

3. The method as set forth in claim 2, wherein the at least one item includes N items where N is at least two and the generating a new sale offer comprises generating an optimal non-deterministic new sale offer having an optimized new sale price and an optimized non-deterministic consideration for the new sale price.

4. The method as set forth in claim 1, wherein the non-deterministic consideration of the at least one non-deterministic sale offer is a probabilistic consideration having a probability P of receiving the at least one item and a probability (1−P) of not receiving the at least one item.

5. The method as set forth in claim 1, wherein the at least one item includes N items where N is at least two and the non-deterministic consideration of the at least one non-deterministic sale offer is receipt of one of the N items with the item received determined probabilistically.

6. The method of claim 1, wherein each sale offer of the plurality of sale offers has a different valuation range over which the sale offer maximizes the buyer's surplus, and the generating buyer valuation information comprises:
identifying a buyer valuation range for each buyer decision wherein the identified buyer valuation range is the valuation range over which the selected sale offer maximizes the buyer's surplus.

7. The method of claim 1, wherein the plurality of sale offers have different buyer surplus versus buyer valuation functions.

8. The method as set forth in claim 1, wherein the at least one non-deterministic sale offer having a sale price and non-deterministic consideration for the sale price comprises a plurality of non-deterministic sale offers having different buyer's surpluses for a given buyer valuation.

9. The method of claim 8, wherein each non-deterministic sale offer has a different valuation range over which the non-deterministic sale offer maximizes the buyer's surplus, and the generating buyer valuation information comprises:
identifying a buyer valuation range for each buyer decision selecting a non-deterministic sale offer wherein the identified buyer valuation range is the valuation range over which the selected non-deterministic sale offer maximizes the buyer's surplus.

10. The method of claim 8, wherein the plurality of non-deterministic sale offers have different positive buyer's surplus versus buyer valuation slopes.

11. A digital processor configured to perform a method as set forth in claim 1.

12. A storage medium storing instructions executable by a digital processor to perform a method as set forth in claim 1.

13. A method comprising:
presenting a plurality of offers to one or more offerees, the offers including at least one non-deterministic offer having non-deterministic consideration for the offeree;
conducting business activity including the presenting and further including at least one actual business transaction executed in response to an acceptance by an offeree of one of the plurality of offers;
receiving offeree decision data during the conducting of business activity; and
generating valuation information based on the offeree decision data.

14. The method of claim 13, wherein one of:
(i) the plurality of offers comprise a plurality of sale offers and the one or more offerees comprise one or more buyers, and
(ii) the plurality of offers comprise a plurality of purchase offers and the one or more offerees comprise one or more sellers.

15. The method as set forth in claim 13, further comprising:
generating a new offer based on the generated valuation information; and
conducting additional business activity including presenting the new offer.

16. The method as set forth in claim 15, wherein the method is performed using n offeree folds wherein the generating of a new offer for an i^{th} offeree fold is based on the generated valuation information for offeree folds other than the i^{th} offeree fold.

17. The method as set forth in claim 15, wherein the at least one item includes N items where N is at least two and the generating a new offer comprises generating an optimal non-deterministic new offer having optimized non-deterministic consideration for the offeree.

18. The method as set forth in claim 13, wherein the non-deterministic consideration for the offeree of the at least one non-deterministic offer is a probabilistic consideration having (i) a probability P of receiving at least one item or a sale price and (ii) a probability (1−P) of receiving nothing.

19. A method comprising:
clustering offerees into n folds based on information indicative of likelihood of offeree-offeree collusion; and
conducting valuation learning for each fold using valuation information obtained solely from the other (n−1) folds.

20. The method of claim 19, wherein the offerees are buyers and the conducting of valuation learning for each fold comprises:
presenting a plurality of sale offers for at least one item for sale to buyers of the fold, the sale offers including at least one non-deterministic sale offer having a sale price and non-deterministic consideration for the sale price;
conducting selling activity with buyers of the fold including the presenting and further including at least one actual sale transacted in accordance with a sale offer of the plurality of sale offers accepted by a buyer of the fold;
receiving buyer decision data for the fold during the conducting of selling activity; and
generating buyer valuation information for the other (n−1) folds based on the buyer decision data for the fold.
